(19) United States
(12) Patent Application Publication
(10) Pub. No.: US 2017/0094528 A1
(43) Pub. Date: Mar. 30, 2017

(54) USER TERMINAL, RADIO BASE STATION, RADIO COMMUNICATION METHOD AND RADIO COMMUNICATION SYSTEM

(71) Applicant: NTT DOCOMO, INC., Tokyo (JP)

(72) Inventors: Kazuaki Takeda, Tokyo (JP); Yoshifumi Morihiro, Tokyo (JP); Hiroki Harada, Tokyo (JP); Satoshi Nagata, Tokyo (JP); Kazuki Takeda, Tokyo (JP)

(73) Assignee: NTT DOCOMO, INC., Tokyo (JP)

(21) Appl. No.: 15/311,107

(22) PCT Filed: May 13, 2015
(86) PCT No.: PCT/JP2015/063715

§ 371 Date: Nov. 14, 2016

(30) Foreign Application Priority Data
May 15, 2014 (JP) 2014-101528

(51) Int. Cl. H04W 16/14; H04W 72/04

(52) U.S. Cl. CPC H04W 16/14; H04W 72/042

(57) ABSTRACT

A user terminal that can communicate with a radio base station by using a licensed band and an unlicensed band is disclosed. The user terminal includes a receiving section that receives downlink signals transmitted in the licensed band and the unlicensed band, a measurement section that measures a downlink signal transmitted in the unlicensed band, and a control section that controls feedback of a measurement result. The receiving section receives information related to a command for the measurement in the unlicensed band and/or a command for the feedback of the measurement result by using the licensed band.

### TECHNICAL FIELD

The present invention relates to a user terminal, a radio base station, a radio communication method and a radio communication system that are applicable to a next-generation communication system.

### BACKGROUND ART

In the UMTS (Universal Mobile Telecommunications System) network, the specifications of long term evolution (LTE) have been drafted for the purpose of further increasing high speed data rates, providing lower delays and so on (see non-patent literature 1). In LTE, as multiple access schemes, a scheme that is based on OFDMA (Orthogonal Frequency Division Multiple Access) is used in downlink channels (downlink), and a scheme that is based on SC-FDMA (Single Carrier Frequency Division Multiple Access) is used in uplink channels (uplink). Successor systems of LTE (referred to as, for example, “LTE-advanced” or “LTE enhancement” (hereinafter referred to as “LTE-A”)) have been under study for the purpose of achieving further broadbandization and increased speed beyond LTE, and the specifications thereof have been drafted (LTE Rel. 10/11).

For LTE-A systems, a HetNet (Heterogeneous Network), in which small cells (for example, pico cells, femto cells and so on) having a local coverage area of a radius of approximately several tens of meters are formed inside a macro cell having a wide coverage area of a radius of approximately several kilometers, is under study. Also, in relationship to the HetNet, a study is in progress to use carriers of different frequency bands between the macro cell (macro base station) and the small cells (small base stations), in addition to the same frequency band.

Furthermore, for future radio communication systems (Rel. 12 and later versions), a system (LTE-U: LTE Unlicensed) to run an LTE system not only in a frequency band that is licensed to a communications provider (operator) (licensed band), but also in a frequency band where license is not required (unlicensed band), is under study. A licensed band is a band in which a specific provider is allowed exclusive use, and an unlicensed band is a band which is not limited to a specific provider and in which radio stations can be provided.

For unlicensed bands, for example, the 2.4 GHz band and the 5 GHz band where Wi-Fi and Bluetooth (registered trademark) can be used and the 60 GHz band where millimeter-wave radars can be used are under study for use. Studies are in progress to use such unlicensed bands in small cells.

### CITATION LIST

### Non-Patent Literature

Non-Patent Literature 1: 3GPP TS 36.300 “Evolved UTRA and Evolved UTRAN Overall Description”

### SUMMARY OF INVENTION

### Technical Problem

A HetNet is anticipated to place many small cells in a macro cell. In an environment like this, a user terminal needs to adequately receive predetermined DL signals (for example, reference signals, detection/measurement signals and so on) that are transmitted from every small cell, so that the user terminal can efficiently detect small cells, measure received quality and so on.

Meanwhile, when LTE is run in an unlicensed band, it is necessary to operate LTE by taking into account the cross-interference with other systems that are run in the same frequency such as Wi-Fi, other operators' LTE-U systems and so on. So, in order to prevent cross-interference, there is an ongoing study to allow an LTE-U base station to perform listening before carrying out transmission, and check whether communication is in progress in transmission points of other systems or other operators' LTE-U systems. However, since, in this case, it is not possible to know when DL signals are transmitted on the user terminal end, there is a fear that it is not possible adequately detect, or measure the received quality of, transmission points that are run in LTE-U.

The present invention has been made in view of the above, and it is therefore an object of the present invention to provide a user terminal, a radio base station, a radio communication method and a radio communication system to allow a user terminal to adequately detect and/or measure transmission points or cells that use an unlicensed band (LTE-U).

### Solution to Problem

One aspect of the present invention provides a user terminal that can communicate with a radio base station by using a licensed band and an unlicensed band, and that has a receiving section that receives DL signals transmitted in the licensed band and the unlicensed band, a measurement section that measures a DL signal transmitted in the unlicensed band, and a control section that controls feedback of a measurement result, and, in this user terminal, the receiving section receives information related to a command for the measurement in the unlicensed band and/or a command for the feedback of the measurement result by using the licensed band.

### Advantageous Effects of Invention

According to one aspect of the present invention, a user terminal can adequately detect and/or measure transmission points or cells that use an unlicensed band (LTE-U).

### BRIEF DESCRIPTION OF DRAWINGS

FIG. 1 is a diagram to show examples of modes of operation when LTE is used in an unlicensed band;

FIG. 2 provide diagrams to show examples of modes of operation when LTE is used in an unlicensed band;

FIG. 3 is a diagram to show intra-cell interference and inter-cell interference in an unlicensed band;

FIG. 4 is a diagram to show an example of a method in which an LTE-U base station controls DL transmission by means of LBT;

FIG. 5 is a diagram to explain a communication method to use a licensed band and an unlicensed band according to the present embodiment;

FIGS. 6 provide diagrams to show an example of a CIF table that can be used in the present embodiment;

FIG. 7 is a diagram to show another example of a CIF table that can be used in the present embodiment;

FIG. 8 is a diagram to show examples of a CIF table and CSI request fields that can be used in the present embodiment;

FIG. 9 is a diagram to show an example of a flowchart according to the present embodiment;

FIG. 10 is a schematic diagram to show an example of a radio communication system according to the present embodiment;

FIG. 11 is a diagram to explain an overall structure of a radio base station according to the present embodiment;

FIG. 12 is a diagram to explain a functional structure of a radio base station according to the present embodiment;

FIG. 13 is a diagram to explain a functional structure of a user terminal according to the present embodiment; and

FIG. 14 is a diagram to explain a functional structure of a user terminal according to the present embodiment.

### DESCRIPTION OF EMBODIMENTS

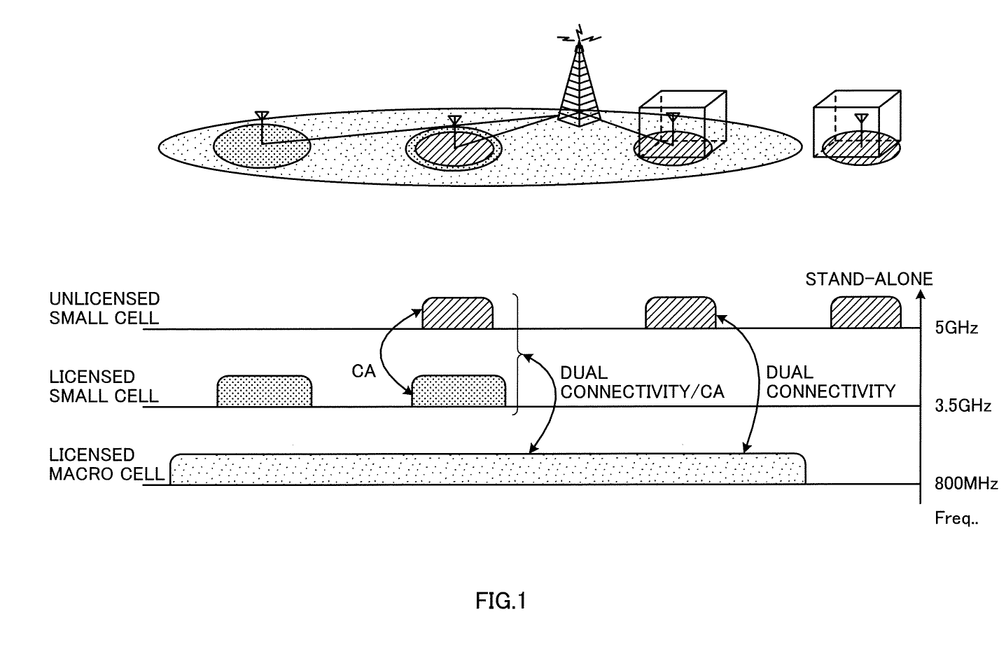

FIG. 1 shows an example of a structure of a radio communication system (LTE-U) to run LTE in an unlicensed band. As shown in FIG. 1, as scenarios to use LTE in an unlicensed band, a plurality of scenarios (carrier aggregation (CA), dual connectivity (DC) and stand-alone) are possible.

For example, assume a case where a macro cell to use a licensed band (for example, the 800 MHz band), a small cell to use a licensed band (for example, the 3.5 GHz band) and a small cell to use an unlicensed band (for example, the 5 GHz band) are provided. Note that cells that employ CA are arranged so that their coverage areas overlap each other at least in part.

In this case, a scenario to apply CA or DC among the macro cell to use the licensed band, the small cell to use the licensed band and the small cell to use the unlicensed band may be possible. For example, CA may be applied assuming that the macro cell to use the licensed band is the primary cell (PCell), and the small cell to use the licensed band and the small cell to use the unlicensed band are secondary cells (SCells).

Also, a scenario to apply CA between the small cell to use the licensed band and the small cell to use the unlicensed band may be possible. In this case, it is possible to make the cell to use the licensed band the PCell and the cell to use the unlicensed band an SCell. Alternatively, a scenario to apply CA or DC between the macro cell to use the licensed band and the small cell to use the unlicensed band may be possible.

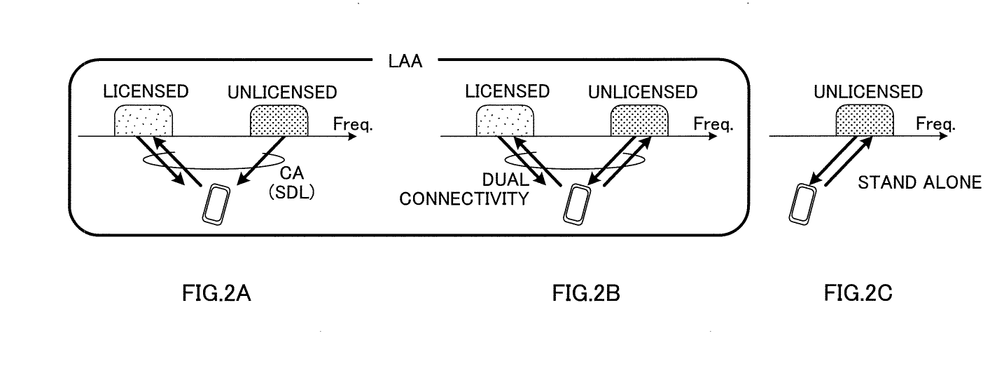

Note that the scenarios that are applicable to the present embodiment are by no means limited to the structure of FIG. 1. Now, each scenario will be described below with reference to FIG. 2.

FIG. 2A shows a mode of operation to apply carrier aggregation (CA) by using a licensed band and an unlicensed band. Also, FIG. 2B shows a mode of operation to apply dual connectivity (DC) by using a licensed and an unlicensed band. Furthermore, FIG. 2C shows a mode of operation to apply stand-alone by using an unlicensed band. Note that, in the following description, a radio base station to run LTE in an unlicensed band will be also referred to as an “LTE-U base station.”

Carrier aggregation (CA), which is shown in FIG. 2A, refers to a technique to bundle a plurality of component carriers (also referred to as “CCs,” “carriers,” “cells,” etc.) into a wide band. Each CC has, for example, a maximum 20 MHz bandwidth, so that, when maximum five CCs are bundled, a wide band of maximum 100 MHz is provided.

When CA is employed, one radio base station's scheduler controls the scheduling of a plurality of CCs. Based on this, CA may be also referred to as “intra-base station CA” (intra-eNB CA) as well. Furthermore, as shown in FIG. 2A, it is possible to use an unlicensed band as a supplemental downlink (SDL) (without configuring a UL carrier). The supplemental downlink here refers to a carrier (band) that is used exclusively for DL communication.

Note that, with the present embodiment, a DL signal in the licensed band and a DL signal in the unlicensed band can be transmitted from one transmission point (for example, a radio base station) (co-located). In this case, an LTE-U base station can communicate with a user terminal by using the licensed band and the unlicensed band. Alternatively, it is equally possible to transmit a DL signal in the licensed band and a DL signal in the unlicensed band from different transmission points (for example, one from a radio base station and the other one from an RRH (Remote Radio Head) that is connected with the radio base station) (non-co-located).

Dual connectivity (DC), which is shown in FIG. 2B, is the same as CA in bundling a plurality of CCs into a wide band. When DC is employed, a plurality of schedulers are provided individually, and these multiple schedulers each control the scheduling of one or more cells (CCs) managed thereunder. Based on this, DC may be referred to as “inter-base station CA” (inter-eNB CA). For example, in DC, DL signals to use a licensed band and an unlicensed band are transmitted from varying transmission points (for example, different radio base stations).

In stand-alone, which is shown in FIG. 2C, a cell (LTE-U base station) to run LTE by using an unlicensed band works alone. In this case, a user terminal can make an initial connection with the LTE-U base station. Consequently, in the operation mode of stand-alone, a scenario to allow non-operators (for example, individuals) to set up LTE-U base stations (access points) may be possible.

Note that, as shown in above FIG. 2A (CA) and FIG. 2B (DC), a mode to presume the presence of licensed band LTE (licensed LTE) in the operation of LTE-U is also referred to as “licensed band assist access” (LAA: Licensed-Assisted Access). In LAA, licensed band LTE and unlicensed band LTE cooperate for communication with user terminals.

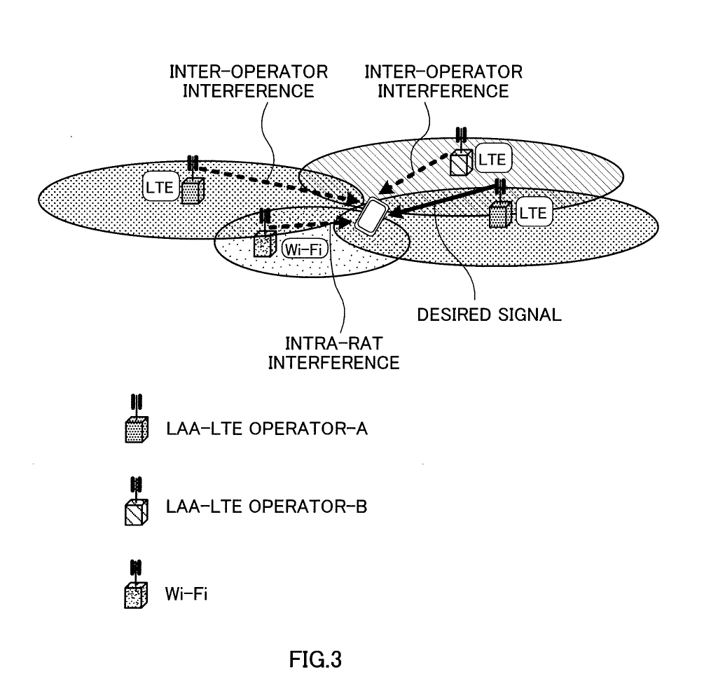

Furthermore, future systems might run small cells by using a TDD band (for example, 3.5 GHz) in addition to small cells that are run in an FDD band. To do so, in LAA systems, in order to reduce the cross-interference with other transmission points, interference may be reduced by introducing intra-operator synchronization (FDD and TDD) and inter-operator synchronization (TDD) for synchronization between transmission points (between antenna ports) (see FIG. 3).

Note that LAA may assume a structure, in which a transmission point to use a licensed band (for example, a radio base station) and a transmission point to use an unlicensed band are, when being a distance apart, connected via a backhaul link (for example, optical fiber, the X2 interface and so on).

Also, in the operation modes of CA/DC shown in FIG. 2A and FIG. 2B, for example, the licensed band CC can be used as the primary cell (PCell) and the unlicensed band CC can be used as a secondary cell (SCell). Here, the primary cell (PCell) refers to the cell that manages RRC connection, handover and so on when CA is executed, and is a cell that requires UL communication in order to receive data and feedback signals from terminals. When CA is executed, the primary cell is always configured in the uplink and the downlink. A secondary cell (SCell) refers to another cell that is configured apart from the primary cell when CA is employed. A secondary cell may be configured in the downlink alone, or may be configured in both the uplink and the downlink at the same time.

Now, conventional LTE presumes operation in a licensed band, and therefore each operator is allocated a different frequency band. However, unlike a licensed band, an unlicensed band is not limited to use by a specific provider. Consequently, there is a possibility that the frequency band which a given operator uses in LTE-U overlaps the frequency band which another operator uses in LTE-U and/or in Wi-Fi.

LTE, when run in an unlicensed band, may be run without even synchronization, coordination and/or cooperation between different operators and/or non-operators. In this case, a plurality of operators and so on share and use the same frequency in the unlicensed band, and therefore there is a fear that cross-interference may be produced.

In Wi-Fi systems that are run in unlicensed bands, carrier sense multiple access/collision avoidance (CSMA/CA), which is based on the mechanism of LBT (Listen Before Talk), is employed. To be more specific, a method, in which each transmission point (TP) or access point (AP) performs “listening” (CCA: Clear Channel Assessment) before carrying out transmission, and carries out DL transmission only when there is no signal beyond a predetermined level, is used.

So, in LTE-U systems, as in Wi-Fi systems, a method (LBT) to stop DL communication depending on the result of listening may be used. For example, an unlicensed band cell performs listening before transmitting a DL signal and checks whether communication is in progress in transmission points of other systems (for example, Wi-Fi) and/or other LAAs (LTE-U).

If, as a result of listening, no signal from other systems and/or other LAA transmission points is detected, communication with user terminals is established in the unlicensed band. On the other hand, if, as a result of listening, signals from transmission points of other system and/or other LAAs are detected, a transition to another carrier is made by way of DFS (Dynamic Frequency Selection), transmission power control (TPC) is applied, or DL transmission may be held (stopped).

Meanwhile, in a scenario to place a plurality of small cells in a macro cell, it is important to allow a user terminal to efficiently detect and connect with small cells, and/or measure the received quality (receiving conditions) adequately. Consequently, a user terminal needs to receive/measure predetermined DL signals (for example, reference signals, detection/measurement signals, and so on) that are periodically transmitted from each small cell, and report the measurement results (measurement report) adequately.

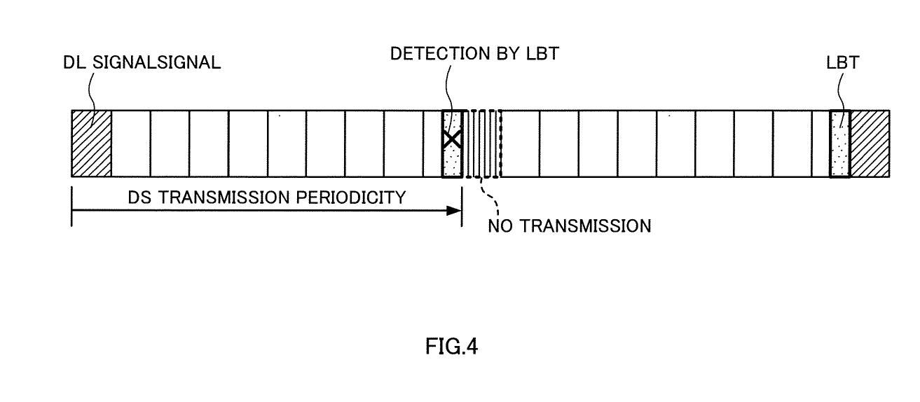

However, when LBT (listening) is employed in a small cell that uses an unlicensed band, cases might occur where LBT that is executed before predetermined DL signals are transmitted periodically stops these DL signals. For example, when a signal of another system or a signal (LAA signal) from another LTE-U operator is detected upon listening in the unlicensed band, the small cell has to stop transmitting DL signals (see FIG. 4).

Meanwhile, the user terminal has no way of knowing that transmission from the small cell using the unlicensed band has been stopped in accordance with LBT, and therefore cannot detect this small cell, and/or measure the DL signals transmitted from the small cell adequately.

Note that the predetermined DL signal to be transmitted in the unlicensed band may be, for example, a detection/measurement signal (DS: Discovery Signal), a channel state measurement reference signal (CSI-RS: Channel State Information Reference Signal) and so on. Furthermore, the measurement of received quality which the user terminal conducts may be, for example, RRM measurement (RSRP and/or RSSI measurement), CSI measurement and so on. That is, the measurement of received quality according to the present embodiment may include measuring received power and/or measuring channel states in the unlicensed band. Obviously, the present embodiment is by no means limited to these.

In this way, although it becomes possible to reduce cross-interference by employing LBT when using an unlicensed band in a small cell, a user terminal becomes unable to receive predetermined DL signals from the small cell while transmission is stopped by LBT. In particular, when DL signals are transmitted in a predetermined periodicity from the small cell using the unlicensed band, depending on the result of LBT, the user terminal may be unable to receive the DL signals for a long period of time. As a result of this, there is a fear that the user terminal cannot receive the DL signals from the small cell adequately, and cannot adequately detect, or measure the received quality of, the small cell.

So, the present inventors have focused on the fact that, in a mode in which a user terminal connects with a licensed band and an unlicensed band (LAA), a small cell (radio base station) under the licensed band can know whether or not transmission is possible in the unlicensed band (LBT result). Furthermore, the present inventors have found out commanding the user terminal to measure the DL signals (for example, the DS, the CSI-RS and so on) transmitted in an unlicensed band cell and/or feed back (report) the measurement results by using a licensed band cell.

By this means, even when LBT is employed in an unlicensed band, the user terminal can adequately detect the unlicensed band cells, measure their received quality, and so on, based on the parameters (for example, the transmission timings) of the unlicensed band cells' DL signals that are reported from the licensed band cells.

Now, the present embodiment will be described below in detail with reference to the accompanying drawings. Note that, although cases will be explained as examples in the following description where LBT is used in an LTE-U operation mode (LAA) that presumes the presence of a licensed band, the present embodiment is by no means limited to this. Also, although cases will be explained as examples in the following description where whether or not to transmit DL signals is controlled based on the result of LBT, the present embodiment is by no means limited to this.

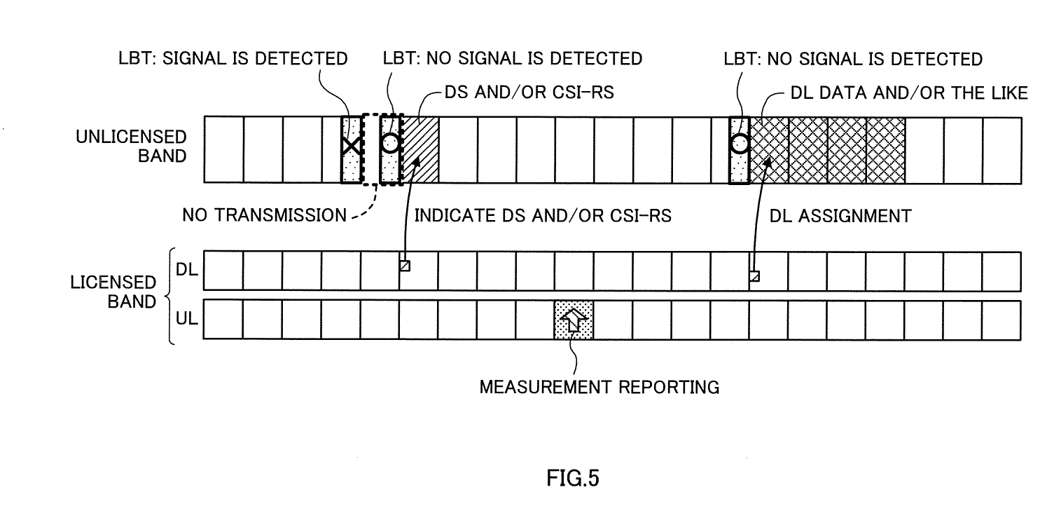

FIG. 5 shows an example of signal transmission in a licensed band and an unlicensed band where LAA (for example, CA) is employed.

A radio base station (unlicensed band cell) performs LBT before transmitting a DL signal in the unlicensed band to control the transmission of this DL signal. If, as a result of LBT, the transmission is judged possible, the unlicensed band cell transmits the DL signal in the unlicensed band. On the other hand, when, as a result of LBT, the transmission is judged not possible, the unlicensed band cell stops transmitting the DL signal (waits for transmission), and performs LBT again after a predetermined period of time.

LBT according to the present embodiment refers to performing listening operation before carrying out DL transmission. Also, the cycle of LBT may be determined in advance to be a predetermined cycle (for example, one to several subframes). Note that a case is illustrated as an example in FIG. 5 where, when transmission is judged not possible as a result of LBT, LBT is performed again one subframe later.

Also, according to the present embodiment, an unlicensed band cell does not only transmit predetermined DL signals in a predetermined cycle, but can transmit predetermined DL signals to user terminals depending on LBT results. The predetermined DL signals might include the detection/measurement signal (DS: Discovery Signal), the channel state measurement reference signal (CSI-RS: Channel State Information Reference Signal) and so on. Also, these are by no means limiting, and the predetermined DL signals might as well include the synchronization signals (PSS/SSS), the positioning reference signal (PRS), the cell-specific reference signal (CRS), the demodulation reference signal (DM-RS), combinations of these signals (for example, the combination of the synchronization signals and the CSI-RS), or new reference signal for unlicensed bands (including modified conventional reference signals).

Also, a radio base station (licensed band cell) knows whether or not an unlicensed band AP that is engaged in CA is capable of transmission (LBT result). The radio base station (licensed band cell), when judging that transmission is possible based on the result of LBT, commands a user terminal to measure the DL signals transmitted in the unlicensed band and/or report the measurement results (measurement/reporting). That is, the radio base station (licensed band cell) reports the transmission timings of the DL signals that are transmitted in the unlicensed band, to the user terminal, by using the licensed band.

For example, when transmitting DL signals in the unlicensed band as a result of LBT, the radio base station (licensed band cell) sends commands to the user terminal by using cross-carrier scheduling. When transmitting the DS and/or the CSI-RS by using the unlicensed band, the radio base station (licensed band cell) sends commands to the user terminal to measure the unlicensed band DL signals and/or report the measurement results through cross-carrier scheduling.

On the other hand, when transmitting DL data (PDSCH signal) by using the unlicensed band, the radio base station (licensed band cell) reports PDSCH allocation information (DL assignment) for the unlicensed band to the user terminal through cross-carrier scheduling. Obviously, it is equally possible to combine and indicate the commands for DL signal measurement and/or measurement result reporting, and the PDSCH allocation information.

Cross-carrier scheduling refers to multiplexing and transmitting downlink control information (DCI) for a given cell (for example, a secondary cell) with a downlink control channel (PDCCH) of another cell (for example, the primary cell) when CA is employed. When this takes place, in order to identify which cell's downlink control information the downlink control information (DCI) that is transmitted in the other cell is, a DCI structure to attach a carrier indicator (CI) is employed.

Also, a carrier indicator field (CIF) for configuring a carrier indicator is attached to the downlink control channel (PDCCH). The user terminal can identify which cell the PDCCH that is allocated corresponds to, by using the bit information constituting the CIF. Note that, in conventional LTE, the CIF is defined to be constituted with three bits.

According to the present embodiment, a radio base station (licensed band cell) can include information to command measurements in the unlicensed band in the CIF, and report this to user terminals. Also, the radio base station can include information regarding which cell's measurement result is fed back, in the CIF, and report this to the user terminal together.

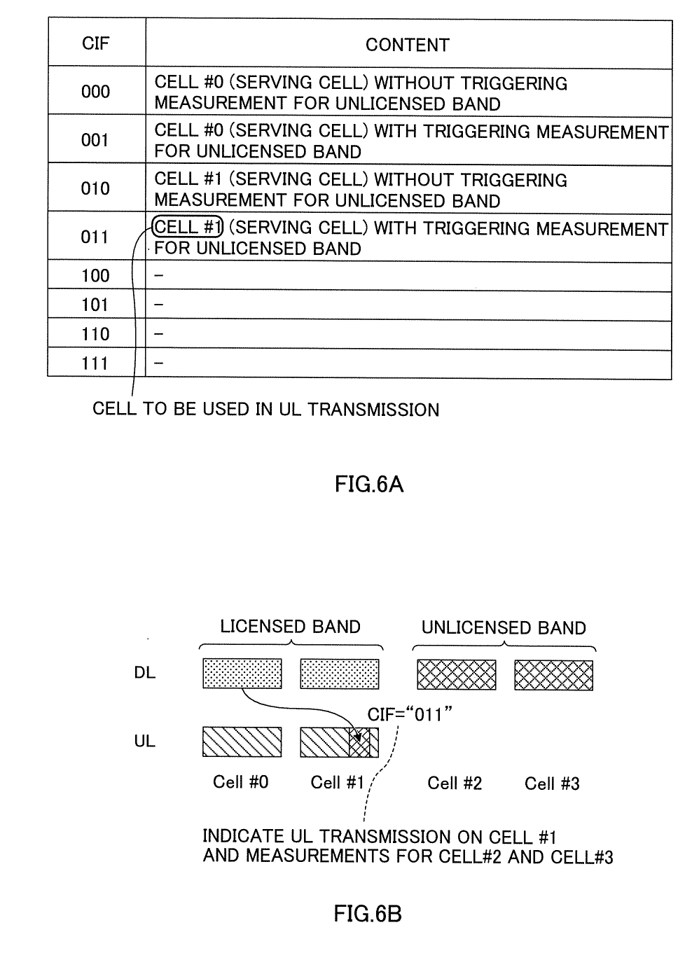

FIG. 6A shows an example of a CIF table that can be used in the present embodiment. Note that FIG. 6A assumes a case where cell #0 and cell #1 to use a licensed band are configured for CA, and where unlicensed band cell #2 and cell #3 are subject to detection and/or measurements (see FIG. 6B). Note that the CIF table of FIG. 6A is applicable regardless of whether or not cell #2 and cell #3 to use the unlicensed band are configured as CA cells (secondary cells). Note that the number of cells that can be applied with the present embodiment is by no means limited to this.

The CIF table shown in FIG. 6A is stipulated so that the cell to use in UL transmission and the command for measurement in the unlicensed band (whether or not measurement is triggered) are combined. Here, a case is shown where the CIF of UL grant is used (for example, DCI formats 0 and 4). For example, when the CIF shows “000,” this indicates that a user terminal performs UL transmission in cell #0 and does not measure the unlicensed band. When the CIF shows “001,” this indicates that the user terminal performs UL transmission in cell #0, and measures the unlicensed band. In this case, the user terminal transmits the measurement result (measurement report) in cell #0 of the licensed band.

Also, when the CIF shows “010,” this indicates that the user terminal performs UL transmission in cell #1 and does not measure the unlicensed band. When the CIF shows “011,” this indicates that the user terminal performs UL transmission in cell #1, and measures the unlicensed band. In this case, the user terminal transmits the measurement result (measurement report) in cell #1 of the licensed band.

Also, referring to FIG. 6B, when the CIF shows “011,” the radio base station (licensed band cell) transmits downlink control information (DCI), including the CIF, by using the PDCCH of cell #0, and commands measurements of unlicensed band cell #2 and cell #3 to the user terminal. After the user terminal receives the downlink control information that is transmitted from cell #1, the user terminal measures unlicensed band cell #2 and cell #3, and transmits a measurement report using UL of cell #1.

In this way, when measurement is triggered with downlink control information, the user terminal can operate on the assumption that the DS and/or the CSI-RS are transmitted in the same timing (same subframe) from the unlicensed band. Also, the user terminal may feed back a measurement report only when a predetermined condition (event) is fulfilled.

In this way, the radio base station can command unlicensed band measurements and/or measurement result reporting to a user terminal through a downlink control channel (PDCCH) of the licensed band, by using cross-carrier scheduling. Also, when the unlicensed band is used as a supplemental downlink (SDL) for exclusive use for DL communication, it is preferable to use the CIF attached to UL grant. This is because, when the unlicensed band is for downlink communication only, UL grant is no longer necessary in the unlicensed band (the CIF attached to UL grant has no meaning). In this case, the CIF attached to the DCI for downlink assignment and the CIF attached to the DCI for uplink grant may be configured separately.

Although a case has been described above where the CIF that is attached to the DCI for UL grant is used, this case is by no means limiting. For example, it is possible to add a field for sending a report when the DS and/or the CSI-RS is transmitted from the unlicensed band, to the CIF that is attached to the DCI for DL assignment. Alternatively, it is equally possible to send a report when the DS and/or the CSI-RS is transmitted, by changing the content of the DCI for DL assignment, without changing the interpretation of the CIF. For example, when the CIF that is attached to the DCI for downlink assignment transmitted in the licensed band indicates the unlicensed band, and, furthermore, the DCI resource allocation all indicates, for example, 0, the UE assumes that the DS and/or the CSI-RS is transmitted in this unlicensed band.

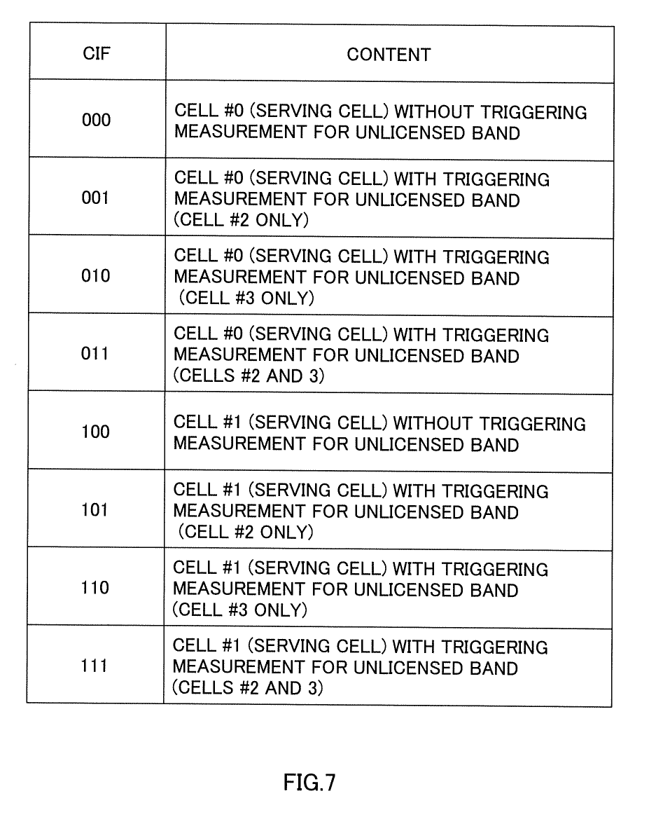

Note that, although a case has been shown above with reference to FIG. 6A where a plurality of unlicensed band cells' measurements are commanded (triggered) together for measurements in the unlicensed band, it is equally possible to control the measurement-target cells to be indicated independently. FIG. 7 shows an example of a CIF table in which the unlicensed band cell that is subject to measurement is specified independently.

FIG. 7 shows a case where which cell (licensed band cell) performs UL transmission, whether or not measurement is carried out, and which specific unlicensed band cell is the target if measurement is carried out are specified in combination. In this way, by indicating the measurement target cell independently, it is possible to reduce the volume of measurement reports which a user terminal feeds back, and allow a radio base station to command desired measurements to user terminals and acquire desired measurement reports.

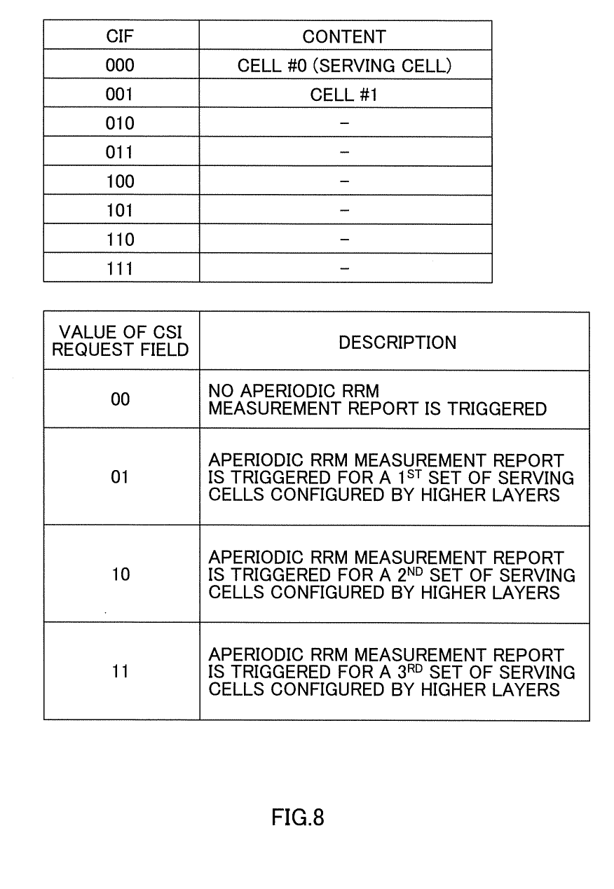

Also, a radio base station can indicate a command for measurement (measurement trigger) in the unlicensed band by using a means other than the CIF. For example, when the DS and the CSI-RS are not transmitted in the same timing (same subframe), the CSI request field (aperiodic CSI trigger) may be used. FIG. 8 shows an example case where the CSI request field is used to command a user terminal to send an unlicensed band measurement report.

FIG. 8 shows a case where whether or not an unlicensed band RRM measurement report is triggered is indicated in the CSI request field. In this case, the contents of the CIF table may specify the cell that corresponds to the PDCCH, as in conventional cases. Also, when the CSI request field is used, the radio base station can report information related to the unlicensed band cells that are subject to measurement (the first set to the third set of cells), to user terminals, in advance, through higher layer signaling (for example, RRC signaling and so on).

<Operation Steps>

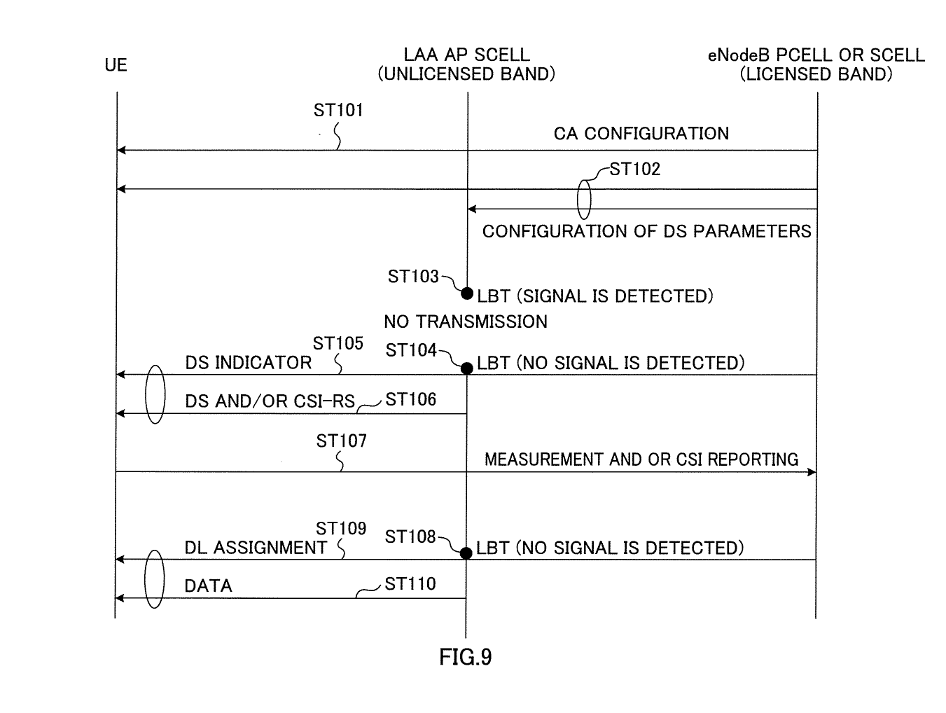

Next, examples of the steps of operation in the radio communication method according to the present embodiment will be described with reference to FIG. 9.

First, a radio base station (a primary cell or a secondary cell) that uses a licensed band configures CA for a user terminal (ST101). For example, the radio base station (licensed band cell) configures the cells to serve as the primary cell and secondary cells for the user terminal.

A licensed band cell is configured as the primary cell. For the secondary cells, licensed band cells and/or unlicensed band cells may be configured. Also, the radio base station does not necessarily have to configure a specific unlicensed band for the secondary cells at this timing.

Next, by using the licensed band, the radio base station (licensed band cell) reports the parameters of the DL signals (for example, the DS, the CSI-RS and so on) for measuring received quality, which are transmitted from the unlicensed band, to the user terminal (ST102). At this time, the radio base station may configure the parameters of the DL signals in the unlicensed band (secondary cells) and report these to the unlicensed band cells.

Next, before transmitting the DL signals using the unlicensed band, the radio base station (unlicensed band cell) performs listening (LBT), and controls whether or not the DL signals can be transmitted based on the result of this listening. For example, when, as a result of LBT, signals that are equal to or greater than a predetermined value from other communication systems and/or other operators' LTE-U are detected (ST103), the radio base station stops the DL transmission in the unlicensed band (waits for transmission).

On the other hand, when, as a result of listening in the unlicensed band, no signal that is equal to or greater than a predetermined value is detected (ST104), the radio base station transmits the DL signals (for example, the DS and/or the CSI-RS) by using the unlicensed band (ST106). Also, using the licensed band, the radio base station (licensed band cell) commands received quality measurements of the DS and/or the CSI-RS transmitted in the unlicensed band and/or reporting of the measurement results (ST105).

In ST105, the radio base station can send commands to the user terminal by using downlink control information (DCI) that is transmitted in the licensed band. To be more specific, as described earlier, by using cross-carrier scheduling, the radio base station can send commands by using the CIF (see FIG. 6A and FIG. 7) and/or send commands by using the CSI request field (see FIG. 8).

Note that, when the DS and the CSI-RS are transmitted using the unlicensed band, the two signals may be transmitted in the same timing (the same subframe) or may be transmitted in different timings (different subframes).

Based on the content commanded in the licensed band, the user terminal measures the received quality in the unlicensed band (RRM measurements and CSI-RS measurements) and/or reports the measurement results (ST107). As for the received quality, the received power (RSRP, RSSI, etc.), the channel states (CSI) and so on of the DL signals transmitted from the unlicensed band are measured. After that, the user terminal feeds back the measurement results in a predetermined cell's UL (for example, UL of a licensed band).

Based on the measurement results (measurement reports) fed back from the user terminal, the radio base station can determine a predetermined unlicensed band cell to transmit DL data to the user terminal.

If, as a result of listening, no signal that is equal to or greater than a predetermined value is detected (ST108), the radio base station (unlicensed band cell) transmits a DL data signal (PUSCH signal) to the user terminal by using the unlicensed band (ST110). At this time, DL assignment-related information in the unlicensed band can be reported to the user terminal through cross-carrier scheduling using downlink control information (PDCCH signal) of the licensed band (ST109).

In this way, commands for measurements of DL signals transmitted in an unlicensed band cells and/or reporting (feedback) of measurement results are given to user terminals by using a licensed band cell, so that the user terminals become capable of adequately detecting unlicensed band cells and/or measuring received quality.

Note that, although a case has been described above where an unlicensed band cell controls whether or not to transmit DL signals based on the result of LBT, the present embodiment is by no means limited to this. The present embodiment is equally applicable even when, for example, transitions are made to other carriers by way of DFS (Dynamic Frequency Selection) depending on the result of LBT, or when transmission power control (TPC) is employed. For example, when a transition is made to another carrier based on LBT, it is possible to report information regarding the carrier to which the transition is made, to a user terminal by using a licensed band. Also, when transmission power control (TPC) is executed based on LBT, it is possible to employ a structure to report transmission power-related information to a user terminal by using a licensed band.

(Structure of Radio Communication System)

Now, the structure of the radio communication system according to the present embodiment will be described below.

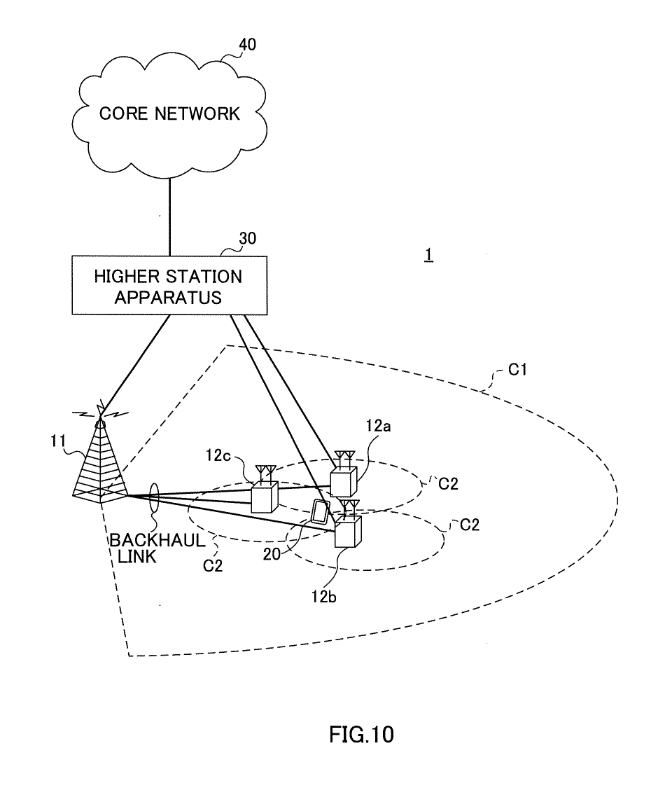

FIG. 10 is a diagram to show a schematic structure of the radio communication system according to the present embodiment. Note that the radio communication system shown in FIG. 10 is, for example, an LTE system, or a system to accommodate SUPER 3G. This radio communication system can adopt carrier aggregation (CA) and/or dual connectivity (DC) to group a plurality of fundamental frequency blocks (component carriers) into one, where the LTE system bandwidth constitutes one unit. Also, the radio communication system shown in FIG. 10 has an unlicensed band (LTE-U base station). Also, this radio communication system may be referred to as “IMT-advanced,” “4G,” “FRA” (Future Radio Access), and so on.

The radio communication system 1 shown in FIG. 10 includes a radio base station 11 that forms a macro cell C1, and radio base stations 12a to 12c that form small cells C2, which are placed within the macro cell C1 and which are narrower than the macro cell C1. Also, user terminals 20 are placed in the macro cell C1 and in each small cell C2. For example, it is possible to employ a structure here where the macro cell C1 is used in a licensed band and the small cells C2 are used in an unlicensed band (LTE-U). Also, a structure to use part of the small cells in a licensed band and use the other small cells in an unlicensed band may be possible.

The user terminals 20 can connect with both the radio base station 11 and the radio base stations 12. The user terminals 20 may use the macro cell C1 and the small cells C2, which use different frequencies, at the same time, by means of CA or DC. For example, it is possible to transmit assist information (DL signal structure) that pertains to the radio base stations 12 (for example, LTE-U base stations) that use the unlicensed band, from the radio base station 11 that uses the licensed band to the user terminals 20. Also, when CA is executed between the licensed band and the unlicensed band, a structure may be employed in which one radio base station (for example, the radio base station 11) controls the scheduling of the licensed band cells and the unlicensed band cells.

Between the user terminals 20 and the radio base station 11, communication can be carried out using a carrier of a relatively low frequency band (for example, 2 GHz) and a narrow bandwidth (referred to as, for example, “existing carrier,” “legacy carrier” and so on). Meanwhile, between the user terminals 20 and the radio base stations 12, a carrier of a relatively high frequency band (for example, 3.5 GHz and so on) and a wide bandwidth may be used, or the same carrier as that used in the radio base station 11 may be used. It is also possible to employ structure in which wire connection (optical fiber, the X2 interface and so on) or wireless connection is established between the radio base station 11 and the radio base stations 12 (or between the radio base stations 12).

The radio base station 11 and the radio base stations 12 are each connected with a higher station apparatus 30, and are connected with a core network 40 via the higher station apparatus 30. Note that the higher station apparatus 30 may be, for example, an access gateway apparatus, a radio network controller (RNC), a mobility management entity (MME) and so on, but is by no means limited to these. Also, each radio base station 12 may be connected with the higher station apparatus 30 via the radio base station 11.

Note that the radio base station 11 is a radio base station having a relatively wide coverage, and may be referred to as an “eNodeB,” a “macro base station,” a “transmitting/receiving point” and so on. Also, the radio base stations 12 are radio base stations having local coverages, and may be referred to as “small base stations,” “pico base stations,” “femto base stations,” “home eNodeBs,” “RRHs (Remote Radio Heads),” “micro base stations,” “transmitting/receiving points” and so on. Hereinafter the radio base stations 11 and 12 will be collectively referred to as a “radio base station 10,” unless specified otherwise. The user terminals 20 are terminals to support various communication schemes such as LTE, LTE-A and so on, and may be either mobile communication terminals or stationary communication terminals.

In the radio communication system, as radio access schemes, OFDMA (Orthogonal Frequency Division Multiple Access) is applied to the downlink, and SC-FDMA (Single-Carrier Frequency Division Multiple Access) is applied to the uplink. OFDMA is a multi-carrier communication scheme to perform communication by dividing a frequency band into a plurality of narrow frequency bands (subcarriers) and mapping data to each subcarrier. SC-FDMA is a single-carrier communication scheme to mitigate interference between terminals by dividing the system band into bands formed with one or continuous resource blocks per terminal, and allowing a plurality of terminals to use mutually different bands.

Now, communication channels used in the radio communication system shown in FIG. 10 will be described. Downlink communication channels include a PDSCH (Physical Downlink Shared CHannel), which is used by each user terminal 20 on a shared basis, and downlink L1/L2 control channels (PDCCH, PCFICH, PHICH and enhanced PDCCH). User data and higher control information are communicated by the PDSCH. Scheduling information for the PDSCH and the PUSCH and so on are communicated by the PDCCH (Physical Downlink Control CHannel). The number of OFDM symbols to use for the PDCCH is communicated by the PCFICH (Physical Control Format Indicator CHannel). HARQ ACKs/NACKs for the PUSCH are communicated by the PHICH (Physical Hybrid-ARQ Indicator CHannel). Also, the scheduling information for the PDSCH and the PUSCH and so on may be communicated by the enhanced PDCCH (EPDCCH) as well. This EPDCCH is frequency-division-multiplexed with the PDSCH (downlink shared data channel).

Uplink communication channels include a PUSCH (Physical Uplink Shared CHannel), which is used by each user terminal 20 on a shared basis as an uplink data channel, and a PUCCH (Physical Uplink Control CHannel), which is an uplink control channel. User data and higher control information are communicated by this PUSCH. Also, by the PUCCH, downlink radio quality information (CQI), delivery acknowledgement signals (ACK/NACK) and so on are communicated.

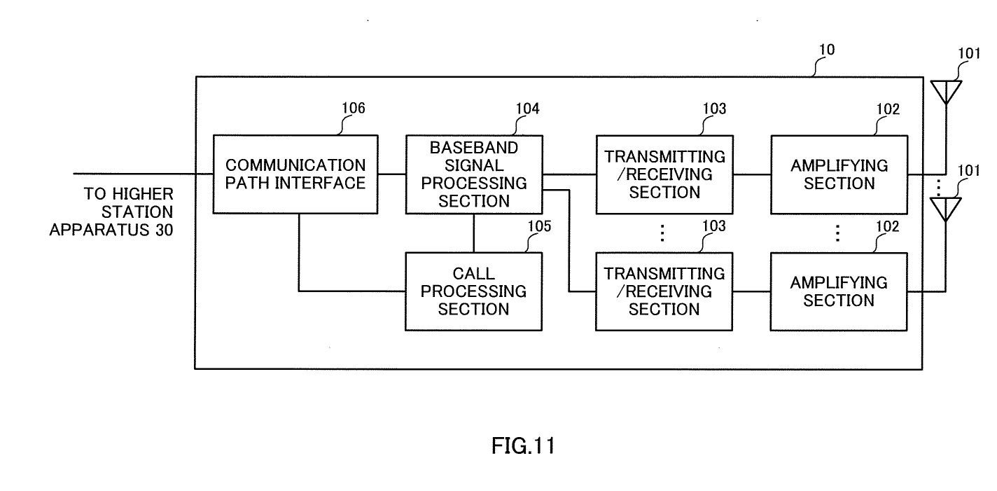

FIG. 11 is a diagram to show an overall structure of a radio base station 10 (which may be either a radio base station 11 or 12) according to the present embodiment. The radio base station 10 has a plurality of transmitting/receiving antennas 101 for MIMO communication, amplifying sections 102, transmitting/receiving sections 103 (transmitting section/receiving section), a baseband signal processing section 104, a call processing section 105 and a communication path interface 106.

User data to be transmitted from the radio base station 10 to a user terminal 20 on the downlink is input from the higher station apparatus 30 to the baseband signal processing section 104, via the communication path interface 106.

In the baseband signal processing section 104, a PDCP layer process, division and coupling of user data, RLC (Radio Link Control) layer transmission processes such as an RLC retransmission control transmission process, MAC (Medium Access Control) retransmission control, including, for example, an HARQ transmission process, scheduling, transport format selection, channel coding, an inverse fast Fourier transform (IFFT) process and a precoding process are performed, and the result is forwarded to each transmitting/receiving section 103. Furthermore, downlink control channel signals are also subjected to transmission processes such as channel coding and an inverse fast Fourier transform, and forwarded to each transmitting/receiving section 103.

Also, the baseband signal processing section 104 reports, to the user terminal 20, control information (system information) for allowing communication in the cell, through higher layer signaling (for example, RRC signaling, broadcast information and so on). The information for allowing communication in the cell includes, for example, the uplink or downlink system bandwidth and so on.

Also, assist information that relates to communication in the unlicensed band (for example, DL TPC information) may be reported from the radio base station (for example, the radio base station 11) to the user terminal, by using the licensed band.

Each transmitting/receiving section 103 converts baseband signals that are pre-coded and output from the baseband signal processing section 104 on a per antenna basis, into a radio frequency band. The amplifying sections 102 amplify the radio frequency signals having been subjected to frequency conversion, and transmit the signals through the transmitting/receiving antennas 101.

On the other hand, as for data to be transmitted from the user terminals 20 to the radio base station 10 on the uplink, radio frequency signals that are received in the transmitting/receiving antennas 101 are each amplified in the amplifying sections 102, converted into the baseband signal through frequency conversion in each transmitting/receiving section 103, and input in the baseband signal processing section 104.

In the baseband signal processing section 104, the user data that is included in the input baseband signal is subjected to an FFT process, an IDFT process, error correction decoding, a MAC retransmission control receiving process, and RLC layer and PDCP layer receiving processes, and the result is forwarded to the higher station apparatus 30 via the communication path interface 106. The call processing section 105 performs call processing such as setting up and releasing communication channels, manages the state of the radio base stations 10 and manages the radio resources.

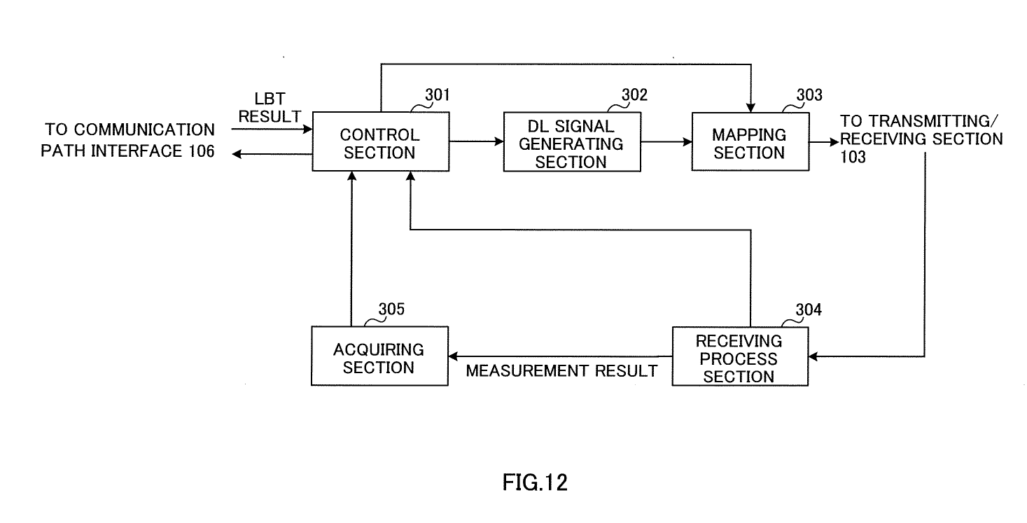

FIG. 12 is a diagram to show a principle functional structure of the baseband signal processing section 104 provided in the radio base station 11 (for example, the radio base station 11 to use the licensed band) according to the present embodiment. Note that FIG. 12 mainly shows function blocks representing parts that are characteristic of the present embodiment, and the radio base station 11 is assumed to have other function blocks that are necessary for radio communication.

As shown in FIG. 12, the radio base station 11 has a control section (scheduler) 301, a DL signal generating section 302, a mapping section 303, a receiving process section 304 and an acquiring section 305.

The control section (scheduler) 301 controls the scheduling of downlink data signals that are transmitted in the PDSCH, downlink control signals that are communicated in the PDCCH and/or the enhanced PDCCH (EPDCCH), and so on. Also, the control section 301 also controls the scheduling of system information, synchronization signals, downlink reference signals such as the CRS and the CSI-RS, and so on. Note that, when the licensed band and the unlicensed band are controlled with one control section (scheduler) 301, the control section 301 controls the transmission of DL signals that are transmitted in the licensed band cells and the unlicensed band cells.

When the control section 301 controls the transmission in the unlicensed band, the control section 301 controls the transmission of DL signals in the unlicensed band based on the result of LBT (Listen Before Talk) executed in the unlicensed band. In this case, the result of LBT executed in an unlicensed band cell is output to the control section 301. For example, when the DL transmission of the unlicensed band cell is carried out from a transmission point (for example, an RRH) that is apart from the licensed band cells, the result of LBT is reported to the control section 301 via a backhaul link. When the DL transmission of an unlicensed band cell is carried out from the same transmission point as that of a licensed band cell, it is possible to execute LBT in the receiving process section 304 and report the result of LBT to the control section 301.

Also, if no signal that is equal to or greater than a predetermined value is detected as a result of LBT in the unlicensed band, the control section 301 controls the DL signals (for example, the DS and/or the CSI-RS) to be transmitted using the unlicensed band. Also, the control section 301 send commands for measurements of the DL signals transmitted in the unlicensed band, feedback of the measurement results and so on, to the user terminal, by using the licensed band. To be more specific, the control section 301 commands the DL signal generating section 302 to generate information related to the unlicensed band measurement command and/or the measurement result feedback command.

The DL signal generating section 302 generates DL signals based on commands from the control section 301. The DL signals might include DL data signals, downlink control signals, reference signals and so on. When DL signals are transmitted in the unlicensed band based on LBT results, the DL signal generating section 302 includes the information related to the unlicensed band measurement command and/or the measurement result feedback command in downlink control signals that are transmitted in the licensed band.

The mapping section 303 controls the mapping of DL signals based on commands from the control section 301.

The receiving process section 304 performs receiving processes (for example, decoding, demodulation and so on) of the UL signals transmitted from the user terminal. When a measurement result (measurement report) that is transmitted from the user terminal via the licensed band is detected, the receiving process section 304 outputs this to the acquiring section 305.

The acquiring section 305 acquires the measurement result that has been measured by the user terminal in the unlicensed band. Also, the acquiring section 305 outputs the measurement result (measurement report) to the control section 301, and the control section 301 can control the unlicensed band cell to transmit DL data to the user terminal based on this measurement result.

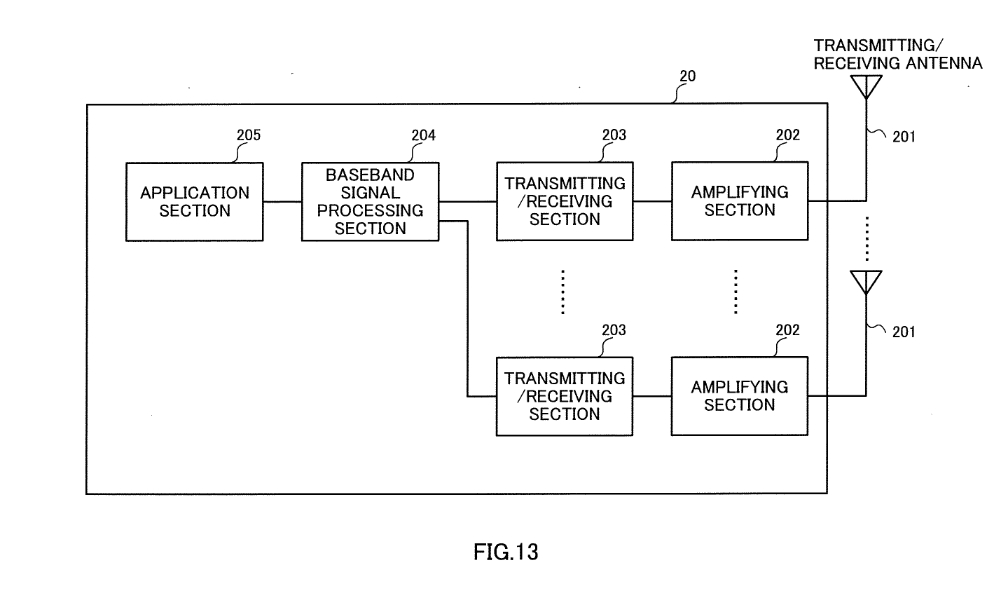

FIG. 13 is a diagram to show an overall structure of a user terminal 20 according to the present embodiment. The user terminal 20 has a plurality of transmitting/receiving antennas 201 for MIMO communication, amplifying sections 202, transmitting/receiving sections (receiving section/transmitting section) 203, a baseband signal processing section 204 and an application section 205.

As for downlink data, radio frequency signals that are received in the plurality of transmitting/receiving antennas 201 are each amplified in the amplifying sections 202, and subjected to frequency conversion and converted into the baseband signal in the transmitting/receiving section 203. This baseband signal is subjected to receiving processes such as an FFT process, error correction decoding and retransmission control (HARQ-ACK), in the baseband signal processing section 204. In this downlink data, downlink user data is forwarded to the application section 205. The application section 205 performs processes related to higher layers above the physical layer and the MAC layer. Also, in the downlink data, broadcast information is also forwarded to the application section 205.

Meanwhile, uplink user data is input from the application section 205 to the baseband signal processing section 204. In the baseband signal processing section 204, a retransmission control (HARQ-ACK) transmission process, channel coding, precoding, a DFT process, an IFFT process and so on are performed, and the result is forwarded to each transmitting/receiving section 203. The baseband signal that is output from the baseband signal processing section 204 is converted into a radio frequency band in the transmitting/receiving sections 203. After that, the amplifying sections 202 amplify the radio frequency signal having been subjected to frequency conversion, and transmit the resulting signal from the transmitting/receiving antennas 201.

Also, the transmitting/receiving sections 203 can receive DL signals from the licensed band and the unlicensed band. Also, the transmitting/receiving sections 203 have only to be capable of transmitting UL signals at least with respect to the licensed band. Obviously, the transmitting/receiving sections 203 may as well be structured to be capable of transmitting UL signals with respect to the unlicensed band. Furthermore, the transmitting/receiving sections 203 function as receiving sections to receive the information related to the unlicensed band measurement command and/or the measurement result feedback command by using the licensed band.

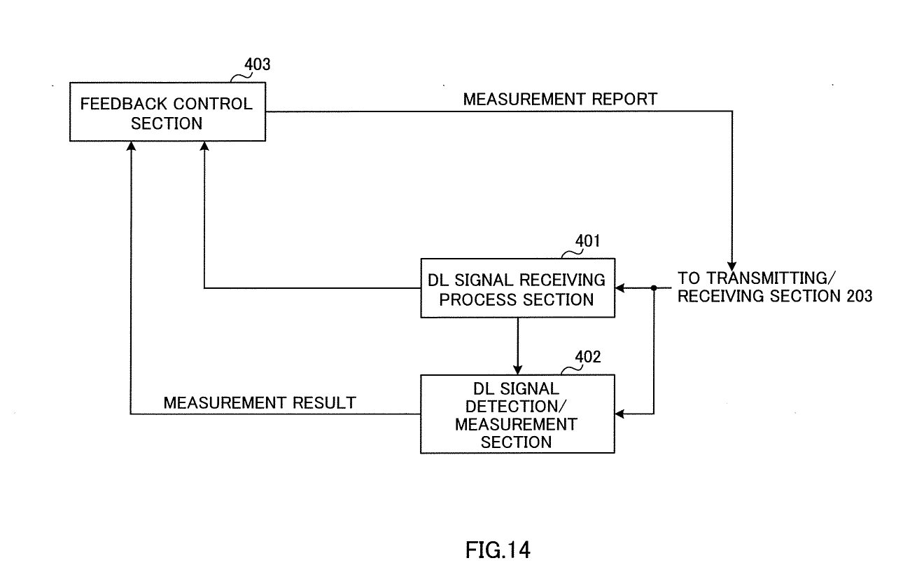

FIG. 14 is a diagram to show a principle functional structure of the baseband signal processing section 204 provided in a user terminal 20. Note that, although FIG. 14 mainly shows function blocks that represent parts that are characteristic of the present embodiment, assume that the user terminal 20 has other function blocks that are required for radio communication as well.

As shown in FIG. 14, the baseband signal processing section 204 provided in the user terminal 20 has a DL signal receiving process section 401, a DL signal detection/measurement section (measurement section) 402 and a feedback control section 403.

The DL signal receiving process section 401 performs receiving processes of the DL signals that are transmitted in the licensed band and the unlicensed band (decoding, demodulation and so on). For example, the DL signal receiving process section 401 acquires the information related to the unlicensed band measurement command and/or the measurement result feedback command included in the CIF and/or the CSI request field included in downlink control signals (DCI) (see above FIG. 6 to FIG. 8). Note that the information that is acquired in the DL signal receiving process section 401 is output to the DL signal detection/measurement section 402 and to the feedback control section 403.

The DL signal detection/measurement section 402 detects and/or measures predetermined DL signals (for example, the DS and/or the CSI-RS, and so on) transmitted in the unlicensed band cells. Based on the information that is output from the DL signal receiving process section 401, the DL signal detection/measurement section 401 can determine the measurement timings in the unlicensed band.

The feedback control section 403 controls the transmission processes (measurement result reporting and so on) of the UL signals for the radio base station. Based on the information that is output from the DL signal receiving process section 401, the feedback control section 403 can determine the cell (for example, a licensed band cell) to transmit the measurement results in the DL signal detection/measurement section 402.

In this way, the user terminal controls unlicensed band measurements and/or measurement result feedback based on information that is reported using a licensed band cell, so that the user terminal becomes capable of adequately detecting unlicensed band cells and/or measuring their received quality, even when LBT is employed in unlicensed band cells.

Note that the radio base stations and user terminals according to the present embodiment have hardware including a communication interface, a processor, a memory, t display and input keys, and, in the memory, software modules to be executed on the processor are stored. Also, the functional structures of the radio base stations and the user terminals may be implemented by using the above-described hardware, may be implemented by using the software modules to be executed on the processor, or may be implemented by combining both of these.

Now, although the present invention has been described in detail with reference to the above embodiment, it should be obvious to a person skilled in the art that the present invention is by no means limited to the embodiment described herein. The present invention can be implemented with various corrections and in various modifications, without departing from the spirit and scope of the present invention defined by the recitations of claims. For example, a plurality of examples described above may be combined and implemented as appropriate. Consequently, the description herein is provided only for the purpose of illustrating examples, and must not be construed to limit the present invention in any way.

The disclosure of Japanese Patent Application No. 2014-101528, filed on May 15, 2014, including the specification, drawings and abstract, is incorporated herein by reference in its entirety.

1. A user terminal that can communicate with a radio base station by using a licensed band and an unlicensed band, the user terminal comprising:
a receiving section that receives DL signals transmitted in the licensed band and the unlicensed band;
a measurement section that measures a DL signal transmitted in the unlicensed band; and
a control section that controls feedback of a measurement result,
wherein the receiving section receives information related to a command for the measurement in the unlicensed band and/or a command for the feedback of the measurement result by using the licensed band.

2. The user terminal according to claim 1, wherein the receiving section receives the information related to the command for the measurement in the unlicensed band and/or the command for the feedback of the measurement result in a downlink control signal of the licensed band.

3. The user terminal according to claim 2, wherein the receiving section receives the information related to the command for the measurement in the unlicensed band and/or the command for the feedback of the measurement result in a CIF (Carrier Indicator Field) and/or a CSI (Channel State Information) request field included in the downlink control signal.

4. The user terminal according to claim 3, wherein whether or not the measurement is carried out in an unlicensed band cell and information about a cell to use to feed back the measurement result are combined to constitute the CIF and/or the CSI request field.

5. The user terminal according to claim 3, wherein a predetermined unlicensed band cell where the measurement is carried out and information about a cell to use to feed back the measurement result are combined to constitute the CIF and/or the CSI request field.

6. The user terminal according to claim 1, wherein the control section controls the measurement result in the unlicensed band to be fed back using the licensed band.

7. The user terminal according to claim 1, wherein LBT (Listen Before Talk) is employed in the unlicensed band.

8. A radio base station that communicates with a user terminal that can use a licensed band and an unlicensed band, the radio base station comprising:
a control section that controls transmission of a DL signal in the unlicensed band by using LBT (Listen Before Talk);
an acquiring section that acquires a measurement result, which the user terminal has measured based on the DL signal transmitted in the unlicensed band; and
a transmission section that transmits information related to a command for the measurement of the DL signal transmitted in the unlicensed band and/or a command for feedback of the measurement result, to the user terminal, by using the licensed band.

9. A radio communication method for a user terminal that connects with a radio base station by using a licensed band and an unlicensed band, the radio communication method comprising the steps of:
receiving DL signals transmitted in the licensed band and the unlicensed band;
measuring a DL signal transmitted in the unlicensed band; and
controlling feedback of a measurement result,
wherein information related to a command for the measurement in the unlicensed band and/or a command for the feedback of the measurement result is received by using the licensed band.

10. (canceled)

11. The user terminal according to one of claim 2, wherein LBT (Listen Before Talk) is employed in the unlicensed band.

12. The user terminal according to one of claim 3, wherein LBT (Listen Before Talk) is employed in the unlicensed band.

13. The user terminal according to one of claim 4, wherein LBT (Listen Before Talk) is employed in the unlicensed band.

14. The user terminal according to one of claim 5, wherein LBT (Listen Before Talk) is employed in the unlicensed band.

15. The user terminal according to one of claim 6, wherein LBT (Listen Before Talk) is employed in the unlicensed band.
